(19) United States
(12) Patent Application Publication
(10) Pub. No.: US 2020/0322947 A1
(43) Pub. Date: Oct. 8, 2020

(54) PHYSICAL UPLINK CONTROL CHANNEL FALLBACK MODE

(71) Applicant: TELEFONAKTIEBOLAGET LM ERICSSON (PUBL), Stockholm (SE)

(72) Inventors: Robert BALDEMAIR, SOLNA (SE); Daniel CHEN LARSSON, LUND (SE)

(21) Appl. No.: 16/755,041

(22) PCT Filed: Oct. 9, 2018
(86) PCT No.: PCT/IB2018/057818

§ 371 Date: Apr. 9, 2020

Related U.S. Application Data
(60) Provisional application No. 62/570,575, filed on Oct. 10, 2017.

(51) Int. Cl. H04W 72/04; H04L 1/18; H04W 72/12; H04B 7/0413

(52) U.S. Cl. CPC H04W 72/0413; H04L 1/1812; H04B 7/0413; H04W 72/1273; H04W 72/1278

(57) ABSTRACT

According to certain embodiments, a method by a wireless device for transmitting hybrid automatic repeat request (HARQ) feedback to a base station is provided. The method includes obtaining a configuration to provide HARQ feedback and determining a HARQ codebook of a first size suitable for providing HARQ feedback for multiple component carriers based at least on the configuration. Downlink scheduling for a number of component carriers is received from a network node. The number of scheduled component carriers is determined to be less than a threshold number of component carriers. A HARQ codebook of a second size that is smaller than the first size is determined based on at least the configuration, and HARQ feedback is sent to the network node using the HARQ codebook of the second size.

### BACKGROUND

In carrier aggregation, multiple component carriers are configured for one user equipment (UE). Component carriers can be configured into so called PUCCH groups. Hybrid Automatic Repeat Request (HARQ) feedback for all component carriers of a PUCCH group are transmitted on the same uplink (UL) using PUCCH or uplink control information (UCI) on physical uplink shared channel (PUSCH).

The acknowledgement/not-acknowledgement (ACK/NACK) bits which should be reported on a single PUCCH are arranged into the HARQ codebook. A HARQ codebook can contain ACK/NACK bits from the same or different component carriers and from one or multiple time instances. New Radio (NR) defines mini-slots and mixing of multiple numerologies on one carrier, and both features can lead to irregular transmission timings complicating the HARQ codebook design. NR also includes HARQ feedback per group of code blocks of a transport block, a feature called Code Block Group (CBG) feedback. The CBG size can range from one code block per CBG to one CBG per transport block (same as in LTE). CBG-based HARQ feedback can substantially increase the amount of HARQ feedback signaling.

In a semi-statically configured HARQ codebook, at least the number of bits in the component carrier dimension is typically fixed. As soon as the UE detects at least one downlink (DL) assignment on any component carrier, the UE prepares a feedback bitmap that contains HARQ feedback of all configured or activated component carriers. Feedback for component carriers where no downlink assignment has been detected for is set to NACK. The number of feedback bits required for one component carrier is given by its multiple input multiple output (MI MO) configuration and its CBG configuration. The number of HARQ feedback bits required for all configured/activated component carriers is the sum across all configured/activated component carriers of the feedback bits required per component carrier.

The number of entries in the time-domain can also be fixed or feedback is only reported for those time instances where at least one downlink assignment is detected (on any of the configured/activated component carriers). In the latter case, a DAI (Downlink Assignment Index) is needed to protect against missed downlink assignments. A DAI is contained in preferably all downlink assignments and contains the number of time instances (e.g., slots) that have been scheduled up to (including) the current slot.

A semi-statically configured HARQ codebook is simple and robust but can lead to high overhead, especially if there are many component carriers and often not all of them are scheduled and/or some component carriers are configured with CBG.

LTE Release 13 supports a very large number of aggregated component carriers. A semi-static configured (in component carrier dimension) HARQ codebook as it has been used in earlier carrier aggregation is suboptimal because, for the semi-statically configured HARQ codebook, feedback of all configured/activated component carriers is always included. With a large number of configured/activated but only a few scheduled component carriers, the HARQ codebook size becomes unnecessarily large. Release 13 includes a dynamic HARQ codebook (in both component carrier and time dimension). Here each downlink assignment (typically a downlink assignment is carried in a DCI) contains a counter and total DAI field. The counter DAI field counts the number of downlink assignments that has been scheduled so far (including the current downlink assignment) for the current HARQ codebook. The component carriers are ordered (e.g. according to carrier frequency) and the counter DAI counts downlink assignments in this order. Along the time axis, the counter DAI is not reset (the counter is increased continuously at slot boundaries). The total DAI in each downlink assignment is set to the total number of downlink assignments that have been scheduled so far (including the current slot) for the current HARQ codebook. The total DAI in a slot is thus set to the highest counter DAI of the slot. To save overhead, a modulo operation such as, for example, often mod 2 is often applied to the counter and total DAI which can then be expressed with a few bits, e.g. 2 bit for mod-2. The counter/total DAI mechanism enables the receiver to recover the HARQ codebook size as well as indexing into the HARQ codebook if few contiguous downlink assignments are missed. FIG. 1 illustrates an example of a counter and total DAI. For simplicity, no modulo operation has been applied in FIG. 1.

PUCCH can carry ACK/NACK (feedback related to HARQ), uplink control information (UCI), scheduling request (SR), or beam related information.

NR defines a variety of different PUCCH formats. On a high level, the available PUCCH formats can be grouped into short and long PUCCH formats.

There are separate short PUCCH formats for ≤2 bit and >2 bit. Short PUCCH can be configured at any symbols within a slot. While for slot-based transmissions short PUCCH towards the end of a slot interval is the typical configuration. PUCCH resources distributed over or early within a slot interval can be used for scheduling request or PUCCH signaling in response to mini-slots.

PUCCH for ≤2 bit uses sequence selection. In sequence selection, the input bit(s) selects one of the available sequences and the input information is presented by the selected sequence. For example, for 1 bit, 2 sequences are required. As another example, for 2 bits, 4 sequences are required. This PUCCH can either span 1 or 2 symbols. Where the PUCCH spans 2 symbols, the same information is transmitted in a second symbol, potentially with another set of sequences (sequence hopping to randomize interference) and at another frequency (to achieve frequency-diversity).

PUCCH for >2 bit uses 1 or 2 symbols. In case of 1 symbol, DM-RS and UCI payload carrying subcarriers are interleaved. The UCI payload is prior mapping to subcarriers encoded (either using Reed Muller codes or Polar codes, depending on the payload). In case of 2 symbols, the encoded UCI payload is mapped to both symbols. For the 2-symbol PUCCH, typically the code rate is halved (in two symbols twice as many coded bits are available) and the second symbol is transmitted at a different frequency (to achieve frequency-diversity).

There are also separate long PUCCH formats ≤2 bit and >2 bit. Both variants exist with variable length ranging from 4 to 14 symbols and can even be aggregated across multiple slots. Long PUCCH can occur at multiple positions within a slot with more or less possible placements depending on the PUCCH length. Long PUCCH can be configured with or without frequency-hopping while the latter has the advantage of frequency-diversity.

Long PUCCH for ≤2 bit is similar to PUCCH format 1a/1b in LTE with the exception that DM-RS are placed differently and the variable-length property.

Long PUCCH for >2 bit uses Time Division Multiplexing (TDM) between Demodulation Reference Signal (DM-RS) and UCI-carrying symbols. UCI payload is encoded (either using Reed Muller codes or Polar codes, depending on the payload), mapped to modulation symbols (typically Quadrature Phase Shift Keying (QPSK) or pi/2 Binary Phase Shift Keying (BPSK)), Discrete Fourier Transform (DFT)-precoded to reduce Peak to Average Power Ratio (PAPR), and mapped to allocated subcarriers for Orthogonal frequency-division multiplexing (OFDM) transmission.

A UE can be configured with multiple PUCCH formats, of the same or different type. Small payload PUCCH formats are needed if a UE is scheduled only with 1 or 2 downlink assignments while a large payload format is needed if the UE is scheduled with multiple downlink assignments. Long PUCCH formats are also needed for better coverage. A UE could for example be configured with a short PUCCH for <2 bit and a long PUCCH for >2 bit. A UE in very good coverage could even use a short PUCCH format for >2 bit while a UE in less good coverage requires even for ≤2 bit a long PUCCH format. FIG. 2 depicts an example of a UE configured with multiple long and short PUCCH formats. The slightly outside resource PR4 should indicate it overlaps PR2 and PR6.

NR supports dynamic indication of PUCCH resource and time. As said above, the HARQ codebook carried by PUCCH can contain HARQ feedback from multiple physical downlink shared channel (PDSCH) (from multiple time instances and/or component carriers). PUCCH resource and time will be indicated in the scheduling downlink assignment in case of a dynamic scheduled transmission. The association between PDSCH and PUCCH can be based on the PUCCH resource (PR) and time indicated in the scheduling DCI (AT). HARQ feedback of all PDSCHs which scheduling DCIs indicate same PUCCH resource and time are reported together in the same HARQ codebook. The latest PDSCH that can be included is limited by the processing time the UE needs to prepare HARQ feedback. FIG. 3 illustrates an example HARQ feedback association. In the depicted example, the UE can report HARQ feedback on a short PUCCH in the same slot. The earliest PDSCH to include in the HARQ codebook for a given PUCCH resource is the first scheduled PDSCH after the time window of the last transmitted same PUCCH resource has been expired. In FIG. 3, PDSCH of slot n−1 is reported on PUCCH resource m of slot n−1. PDSCH from slot n is, therefore, the first PDSCH to include in the HARQ codebook transmitted on PUCCH resource m in slot n+4.

To avoid wrong HARQ codebook sizes and wrong indexing into the HARQ codebook, a DAI is included in each DL assignment that counts DL assignments up to and including the current DL assignment. In case of carrier aggregation, a counter and total DAI are needed as outlined above with respect to the discussion of Dynamic HARQ codebook. In FIG. 3, discussed above, the case without carrier aggregation is shown.

There currently exist certain challenge(s). For example, if a UE is configured with CBG-based feedback together with carrier aggregation and a semi-statically configured HARQ codebook, then the unnecessary overhead can become quite large if the UE is only scheduled on a few or even only one component carrier within a PUCCH group.

A common case is that a UE is only scheduled on one component carrier despite its carrier aggregation configuration. It therefore makes sense to optimize for this case such as, for example, by enabling transmission of HARQ feedback for a single component carrier without the burden of using the larger fixed HARQ codebook.

Certain aspects of the present disclosure and their embodiments may provide solutions to these or other challenges. For example, if a UE only receives a single downlink assignment within a PUCCH group, then it reports HARQ feedback for this single component carrier, despite its semi-statically configured HARQ codebook, carrier aggregation and potentially CBG configuration. If the received downlink assignment is on a component carrier that is configured with CBG-based feedback, then the feedback can either be done using CBG-based feedback or the feedback can be reduced to transport block based feedback as in LTE.

### SUMMARY

To address the foregoing problems with existing solutions, disclosed is systems and methods for transmitting hybrid automatic repeat request (HARQ) feedback to a base station. For example, certain embodiments include optimizing HARQ feedback for a wireless device that is configured with carrier aggregation and a semi-statically configured HARQ codebook but is only scheduled on a single component carrier. In such a scenario, the wireless device may transmit the HARQ feedback using a smaller HARQ codebook rather than by using the carrier aggregation and the larger HARQ codebook.

According to certain embodiments, a method by a wireless device for transmitting HARQ feedback to a base station is provided. The method includes obtaining a configuration to provide HARQ feedback and determining a HARQ codebook of a first size suitable for providing HARQ feedback for multiple component carriers based at least on the configuration. Downlink scheduling for a number of component carriers is received from a network node. The number of scheduled component carriers is determined to be less than a threshold number of component carriers. A HARQ codebook of a second size that is smaller than the first size is determined based at least on the configuration, and HARQ feedback is sent to the network node using the HARQ codebook of the second size.

According to certain embodiments, a wireless device is provided for transmitting HARQ feedback to a base station. The wireless device includes processing circuitry configured to obtain a configuration to provide HARQ feedback. A HARQ codebook of a first size suitable for providing HARQ feedback for multiple component carriers is determined based at least on the configuration. Downlink scheduling for a number of component carriers is received from a network node. The number of scheduled component carriers is determined to be less than a threshold number of component carriers. A HARQ codebook of a second size that is smaller than the first size is determined based at least on the configuration, and HARQ feedback is sent to the network node using the HARQ codebook of the second size.

According to certain embodiments, a method by a base station for scheduling HARQ feedback from a wireless device includes configuring the wireless device to provide HARQ feedback using a HARQ codebook of a first size suitable for providing HARQ feedback for multiple component carriers. Downlink scheduling for a number of component carriers that is less than a threshold number of component carriers is transmitted to the wireless device. In response to the number of component carriers being less than the threshold number of component carriers, HARQ feedback is received with a HARQ codebook of a second size that is smaller than the first size.

According to certain embodiments, a base station is provided for scheduling HARQ feedback from a wireless device. The base station includes processing circuitry configured to configure the wireless device to provide HARQ feedback using a HARQ codebook of a first size suitable for providing HARQ feedback for multiple component carriers. Downlink scheduling for a number of component carriers that is less than a threshold number of component carriers is transmitted to the wireless device. In response to the number of component carriers being less than the threshold number of component carriers, HARQ feedback is received with a HARQ codebook of a second size that is smaller than the first size.

Certain embodiments may provide one or more of the following technical advantage(s).

For example, certain embodiments may reduce overhead for a wireless device that is configured with carrier aggregation using semi-statically configured HARQ codebook (and potentially CBG-based feedback) but only is scheduled on a single component carrier within a PUCCH group.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of a counter and total downlink assignment index (DAI);

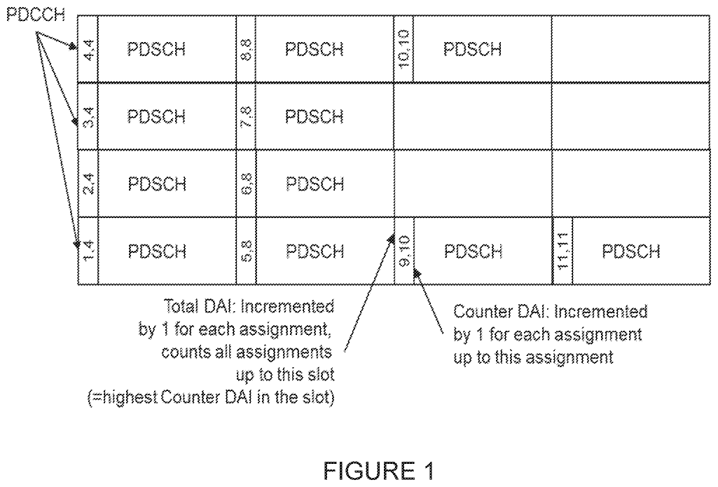

FIG. 2 illustrates an example of a UE configured with multiple long and short PUCCH formats:

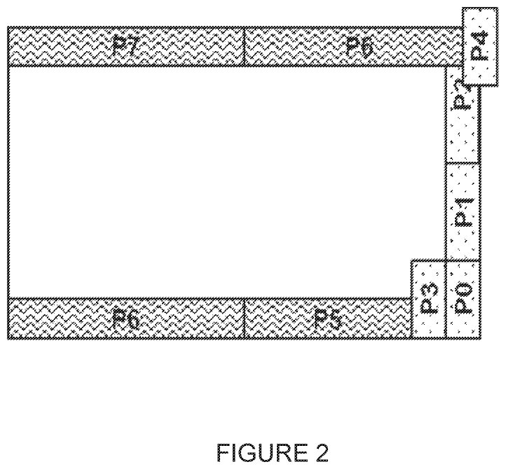

FIG. 3 illustrates an example HARQ feedback association;

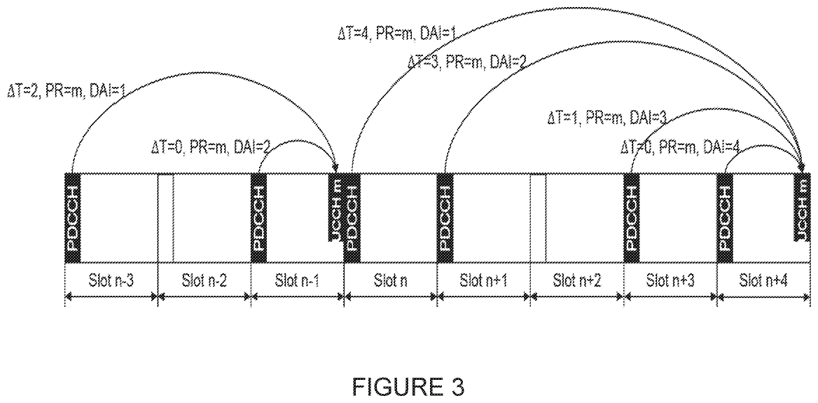

FIG. 4 illustrates an example wireless network, according to certain embodiments:

FIG. 5 illustrate an example network node, according to certain embodiments,

FIG. 6 illustrates an example wireless device, according to certain embodiments;

FIG. 7 illustrates an example user equipment (UE), according to certain embodiments:

FIG. 8 illustrates a virtualization environment in which functions implemented by some embodiments may be virtualized, according to certain embodiments:

FIG. 9 illustrates an example method by a wireless device, according to certain embodiments:

FIG. 10 illustrates an example method by a network node, according to certain embodiments:

FIG. 11 illustrates an example virtualization apparatus in a wireless network, according to certain embodiments;

FIG. 12 illustrates another method for transmitting HARQ feedback by a wireless device, according to certain embodiments:

FIG. 13 illustrates another example virtualization apparatus in a wireless network, according to certain embodiments,

FIG. 14 illustrates another method by a network node for scheduling HARQ feedback from a wireless device, according to certain embodiments; and

FIG. 15 illustrates another example virtualization apparatus in a wireless network, according to certain embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Configuration and/or activation of component carriers is not an instantaneous process—it requires time until a changed configuration takes place. This applies even if the carrier aggregation configuration is not changed, but component carriers are activated or de-activated. As such, despite a UE being configured and active on multiple component carriers, it is not uncommon that a UE is only scheduled on one component carrier. If the UE is then also configured with code block group (CBG)-based hybrid automatic repeat request (HARQ) feedback and a semi-statically configured HARQ codebook, then the overhead for reporting HARQ feedback for a single component carrier can become very large. Given that single component carrier scheduling is not uncommon, it makes sense to optimize for this case.

According to certain embodiments, if a user equipment (UE) receives only one downlink assignment on a single downlink component carrier within a physical uplink control channel (PUCCH) group, then it does not use the semi-statically configured carrier aggregation HARQ codebook, but uses another smaller HARQ codebook adopted for a single HARQ report. The single downlink component carrier can either be any downlink component carrier or it can be a particular one, e.g. 1) the downlink component carrier can be configured, 2) it can be a primary downlink component carrier, 3) it can be a downlink carrier associated with the uplink carrier of the PUCCH group that carries PUCCH. Depending on whether the downlink component carrier for which the downlink assignment is received “qualifies” for the reduced HARQ feedback, the smaller HARQ codebook or the regular semi-statically configured carrier aggregation HARQ codebook is used.

In a particular embodiment, for example, if the downlink component carrier for which the downlink assignment has been received is configured with CBG-based HARQ feedback, then the UE can either report HARQ feedback using the CBG configuration or it reports HARQ feedback with fewer bits. HARQ feedback with fewer bits can be generated by bundling across CBG, either across all to obtain transport block based HARQ feedback (similar to LTE) or across groups of CBG to obtain CBG-based feedback with larger CBG size.

In a particular embodiment, a multi input multiple output (MIMO) configuration may also be used to determine the number of HARQ feedback bits. For example, the UE can either report HARQ feedback according to the MIMO configuration or apply spatial bundling. This can be done or not done independently of the potential feedback reduction in CBG dimension.

According to particular embodiments, the HARQ feedback for the single received downlink assignment can either be sent on the same or a different PUCCH resource. Sending the HARQ feedback on the same PUCCH resource is advantageous in some embodiments because the gNB can use the a-priori knowledge that it scheduled the UE only on one component carrier. As such, despite the “large” PUCCH resource, a decoding improvement can be obtained which can be used either to 1) increase performance or 2) enable the UE to transmit with less power, given that it transmits fewer bits. In the latter case, special uplink power control rules may be specified for how to handle the power for the second, smaller HARQ codebook. The power used for the second, smaller HARQ codebook transmission could be based on, for example, the power control loop of PUCCH together with at least one of 1) the size of a first semi-statically configured HARQ codebook and 2) the size of a second, smaller HARQ codebook.

According to certain embodiments, the second, smaller HARQ codebook may be sent on a “smaller” PUCCH resource. NR uses explicit PUCCH resource allocation where the downlink assignment indicates the PUCCH resource to use. Using this mechanism, it is easy to also switch the PUCCH resource to a smaller PUCCH resource. The UE may either use the size of the second, smaller HARQ codebook and transmit the second, smaller HARQ codebook using the smaller PUCCH” resource. Alternatively, the indicated smaller PUCCH resource might be tagged/configured/assigned with a certain HARQ codebook size to use. In some embodiments, a PUCCH resource may be configured with a HARQ codebook size. In this case, the HARQ feedback of the single downlink assignment is sent using the HARQ codebook size associated with the smaller PUCCH resource. If the actual HARQ feedback size and the codebook size of the smaller PUCCH resource do not match, padding (typically with NACK) or bundling may be applied to match the sizes.

More generally, if a UE that is configured with carrier aggregation and a first semi-statically configured HARQ codebook (with or without CBG) receives one or more downlink assignments and the scheduling PDCCH(s) indicates a PUCCH resource that is too small for the first semi-statically configured carrier aggregation HARQ codebook, the UE may use a second HARQ codebook that fits into the indicated PUCCH resource. The second HARQ codebook can be semi-statically configured or it can be dynamically derived. For example, the second HARQ codebook may be dynamically derived from the number of received downlink assignments. Where the UE is configured with CBG, the UE may apply CBG feedback size reduction such as, for example, via bundling.

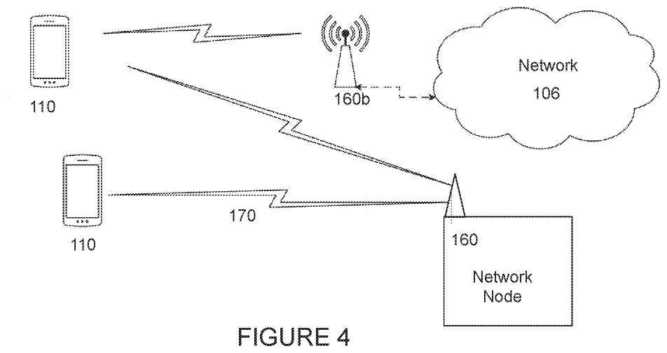

FIG. 4 illustrates a wireless network, according to some embodiments. Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards, and/or any other appropriate wireless communication standard, such as the Worldwide Interoperability for Microwave Access (Wi Max), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

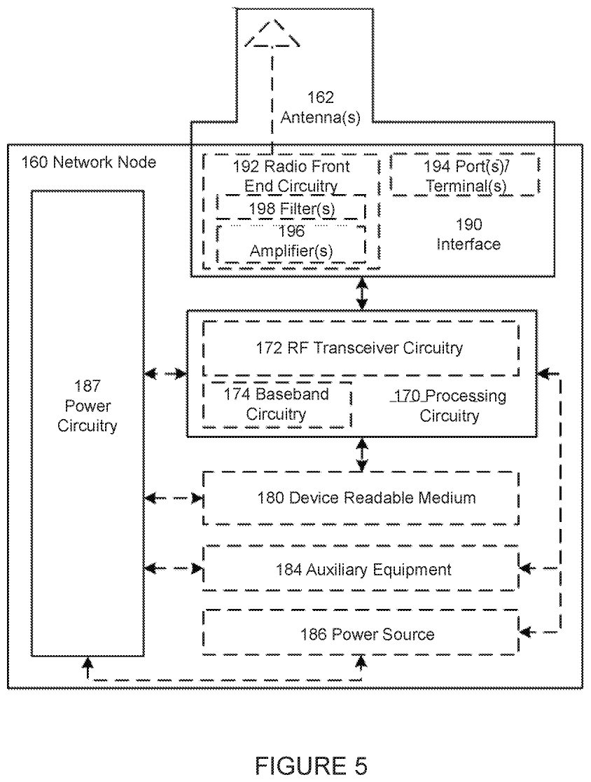

FIG. 5 illustrates an example network node, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 160 includes processing circuitry 170, device readable medium 180, interface 190, auxiliary equipment 184, power source 186, power circuitry 187, and antenna 162. Although network node 160 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186.

Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 5 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

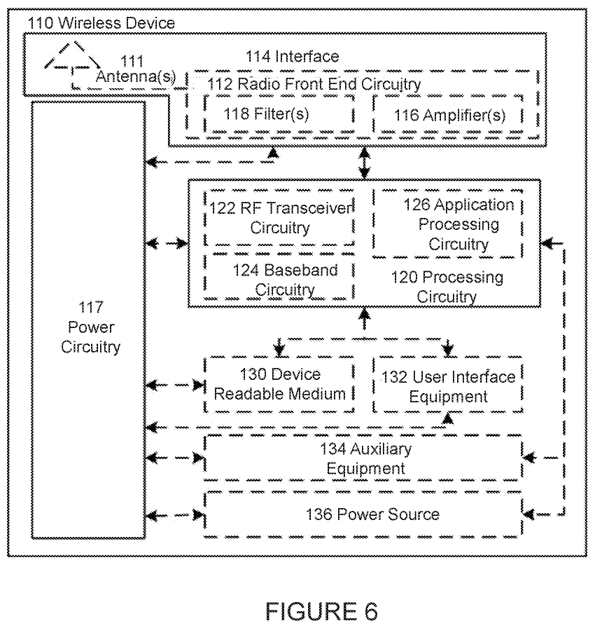

FIG. 6 illustrates an example wireless device (WD), according to particular embodiments. As used herein, WD refers to a device capable, configured, arranged and/or operable to communicate wirelessly with network nodes and/or other wireless devices. Unless otherwise noted, the term WD may be used interchangeably herein with user equipment (UE).

Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (Vol P) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, WD 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface. As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna.

Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein.

Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

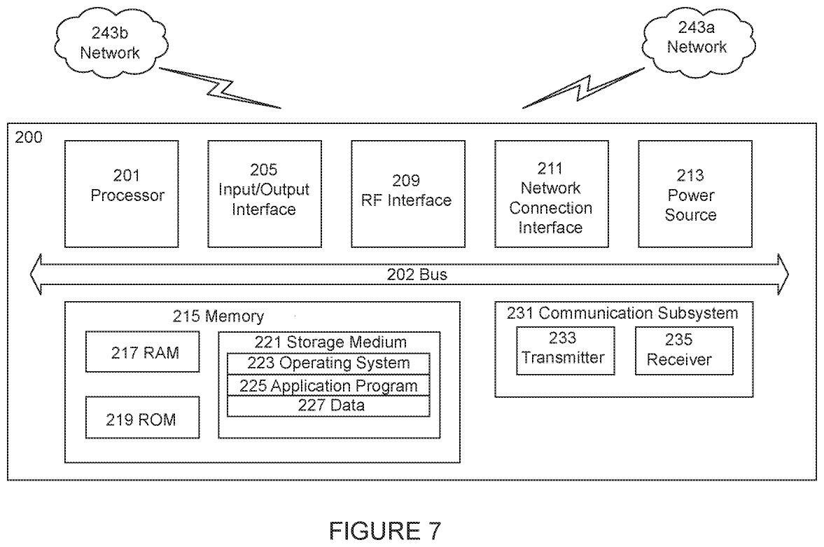

FIG. 7 illustrates an example user equipment (UE), according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 7, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof.

For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

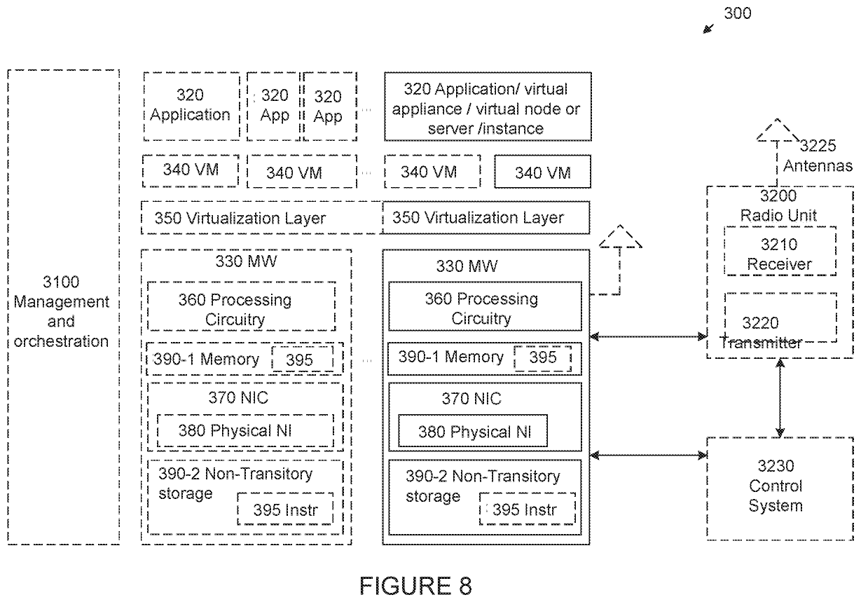

FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g. such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signaling can be effected with the use of control system 8230 which may alternatively be used for communication between the hardware nodes 830 and radio units 8200.

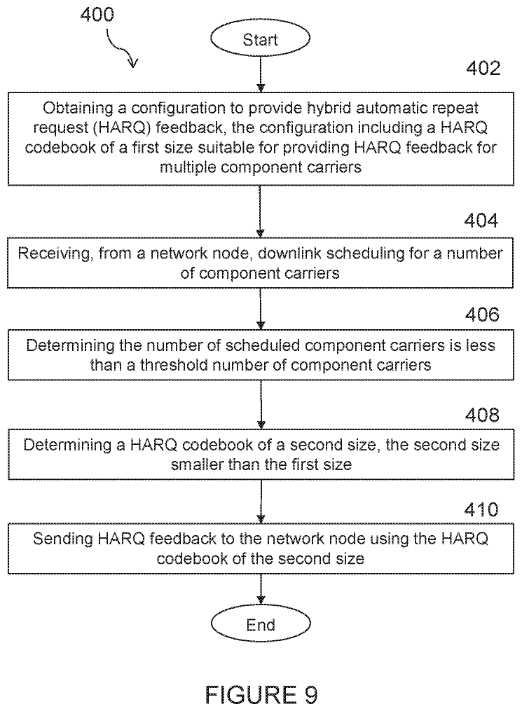

FIG. 9 depicts an example method by a wireless device, according to certain embodiments. The method begins at step 402 with obtaining a configuration to provide hybrid automatic repeat request (HARQ) feedback, the configuration including a HARQ codebook of a first size suitable for providing HARQ feedback for multiple component carriers (e.g. 4), according to any of the embodiments and examples described above. The method proceeds to step 404 with receiving, from a network node, downlink scheduling for a number of component carriers (e.g., 1). At step 406, the wireless device determines the number of scheduled component carriers is less than a threshold number of component carriers (e.g., 1<threshold=2). At step 408, the wireless device determines a HARQ codebook of a second size, the second size smaller than the first size, according to any of the embodiments and examples described above. The method continues to step 410, where the wireless device sends HARQ feedback to the network node using the HARQ codebook of the second size.

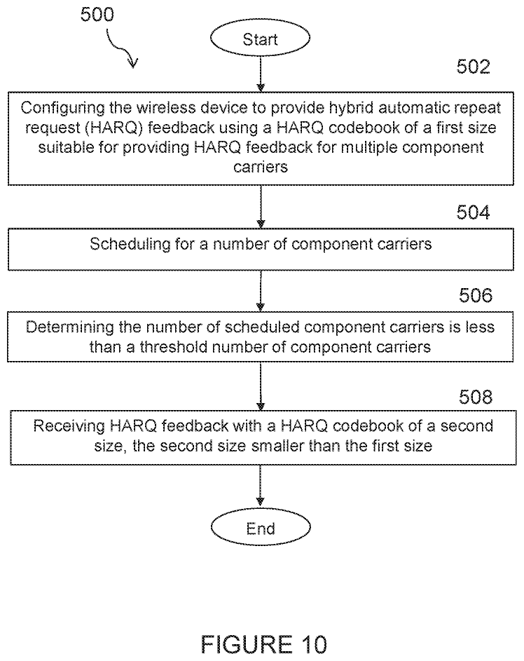

FIG. 10 illustrates an example method by a network node, according to certain particular embodiments. The method begins at step 502 with configuring the wireless device to provide hybrid automatic repeat request (HARQ) feedback using a HARQ codebook of a first size suitable for providing HARQ feedback for multiple component carriers, according to any of the embodiments and examples described above. The method proceeds to step 504 scheduling the wireless device for a number of component carriers carriers (e.g., 1). At step 506, the network node determines the number of scheduled component carriers is less than a threshold number of component carriers (e.g., 1<threshold=2). At step 508, the network node receives HARQ feedback with a HARQ codebook of a second size, the second size smaller than the first size, according to any of the embodiments and examples described above.

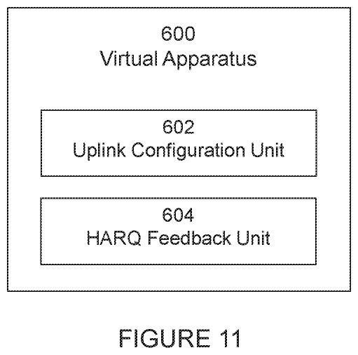

FIG. 11 illustrates an example virtualization apparatus in a wireless network (for example, the wireless network shown in FIG. 4), according to certain embodiments. The apparatus may be implemented in a wireless device or network node (e.g., wireless device 110 or network node 160 shown in FIG. 4). Apparatus 600 is operable to carry out the example method described with reference to FIG. 9 or FIG. 10 and possibly any other processes or methods disclosed herein. It is also to be understood that the methods of FIG. 9 or FIG. 10 are not necessarily carried out solely by apparatus 600. At least some operations of the method can be performed by one or more other entities.

Virtual Apparatus 600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause uplink configuration unit 602, HARQ feedback unit 604 and any other suitable units of apparatus 600 to perform corresponding functions according one or more embodiments of the present disclosure.

As illustrated in FIG. 11, apparatus 600 includes uplink configuration unit 602 and HARQ feedback unit 604. In certain embodiments, such as when uplink configuration unit 602 and HARQ feedback unit 604 are implemented in a wireless device, uplink configuration unit 602 is configured to receive an indication from a base station to use a particular PUCCH resource or codebook for transmitting HARQ feedback. In response to receiving the indication, uplink configuration unit 602 is further configured to change the PUCCH resource or codebook based on downlink scheduling. HARQ feedback unit 604 is configured to transmit the HARQ feedback originally intended to be transmitted on the original PUCCH resource or codebook on the new PUCCH resource or codebook.

In certain embodiments, such as when uplink configuration unit 602 and HARQ feedback unit are implemented in a base station, uplink configuration unit 602 is configured to determine that a wireless device should change a PUCCH resource and/or codebook for transmitting HARQ feedback. HARQ feedback unit 604 is configured to receive the HARQ feedback originally intended to be transmitted on the original PUCCH resource or codebook, on a new PUCCH resource or codebook, based on downlink scheduling.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

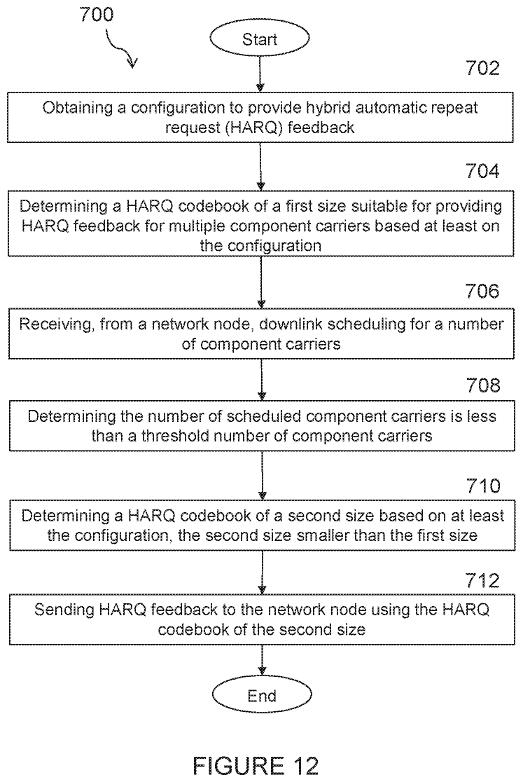

FIG. 12 depicts another method for transmitting HARQ feedback by a wireless device 110, according to certain embodiments. The method begins at step 702 when wireless device 110 obtains a configuration to provide HARQ feedback.

At step 704, wireless device 110 determines a HARQ codebook of a first size suitable for providing HARQ feedback for multiple component carriers based at least on the configuration.

At step 706, wireless device 110 receives, from a network node 160, downlink scheduling for a number of component carriers.

At step 708, wireless device 110 determines the number of scheduled component carriers is less than a threshold number of component carriers.

At step 710, wireless device 110 determines a HARQ codebook of a second size that is smaller than the first size based on at least the configuration. In a particular embodiment, for example, the HARQ codebook of the second size may be fewer bits than the HARQ codebook of the first size.

In a particular embodiment, the HARQ codebook of the second size may be determined based at least in part on a MIMO configuration.

In another particular embodiment, determining the HARQ codebook of the second size comprises generating the HARQ feedback of the second size by bundling across a plurality of code block groups.

In a particular embodiment, the downlink scheduling for the number of component carriers comprises a downlink assignment for each of the number of component carriers, and the size of the HARQ codebook of the second size may be determined based on the number of component carriers.

At step 712, wireless device 110 sends HARQ feedback to the network node using the HARQ codebook of the second size.

In various particular embodiments, the obtained configuration may also include a PUCCH resource of a first size and the HARQ feedback may be sent to network node 160 using a PUCCH resource of a second size that is smaller than the first size of the first PUCCH resource. In an embodiment, the PUCCH resource of the second size may be different from the PUCCH resource of the first size. In another embodiment, the PUCCH resource of the second size may be the same as the PUCCH resource of the first size.

In a particular embodiment, the downlink scheduling received at step 706 is a downlink assignment for a single component carrier within a PUCCH group, and the HARQ feedback sent at step 712 is a single HARQ report for the downlink assignment. In a particular embodiment, the downlink assignment may indicate a PUCCH resource to use for sending the HARQ feedback of the second size to the network node. In another particular embodiment, the HARQ codebook of the second size may be determined based on an association with the PUCCH resource indicated by the downlink assignment. In yet another particular embodiment, the single component carrier may be a primary downlink component carrier. In still another particular embodiment, the single component carrier may be a downlink component carrier associated with an uplink component carrier of a PUCCH group that carries PUSCH.

In a particular embodiment, the method may further include wireless device 110 determining, based on an uplink power control rule, a power level for the HARQ codebook of the second size. The power level may be based on a power control loop of the PUCCH and at least one of: the first size of the larger HARQ codebook and the second size of the smaller HARQ codebook. The power level may be used for sending the HARQ feedback of the second size to the network node 160.

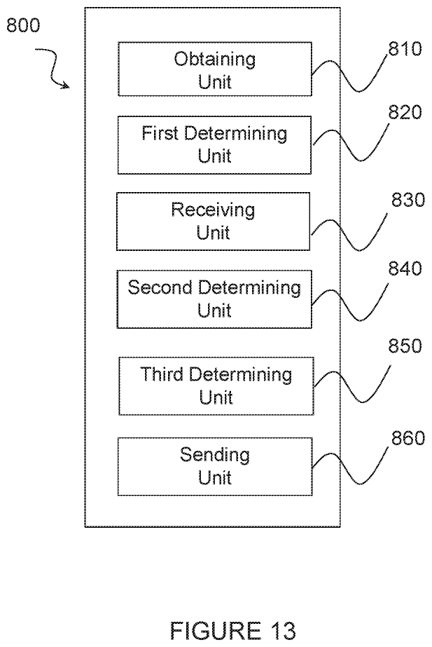

FIG. 13 illustrates another example virtualization apparatus 800 in a wireless network (for example, the wireless network shown in FIG. 4), according to certain embodiments.

Apparatus 800 may be implemented in a wireless device (e.g., wireless device 110 shown in FIG. 4). Apparatus 800 is operable to carry out the example method described with reference to FIG. 12 and possibly any other processes or methods disclosed herein. It is also to be understood that the method of FIG. 12 is not necessarily carried out solely by apparatus 800.

At least some operations of the method can be performed by one or more other entities.

Virtual Apparatus 800 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause obtaining unit 810, first determining unit 820, receiving unit 830, second determining unit 840, third determining unit 850, sending unit 860, and any other suitable units of apparatus 800 to perform corresponding functions according one or more embodiments of the present disclosure.

As illustrated in FIG. 13, apparatus 800 includes obtaining unit 810, first determining unit 820, receiving unit 830, second determining unit 840, third determining unit 850, and sending unit 860. In certain embodiments, obtaining unit 810 is configured to obtain a configuration to provide HARQ feedback. In response to obtaining the configuration, first determining unit 820 is configured to determine a HARQ codebook of a first size suitable for providing HARQ feedback for multiple component carriers based at least on the configuration. Receiving unit 830 is configured to receive, from a network node 160, downlink scheduling for a number of component carriers. In response to receiving the downlink scheduling, second determining unit 840 is configured to determine the number of scheduled component carriers is less than a threshold number of component carriers and third determining unit 850 is configured to determine a HARQ codebook of a second size that is smaller than the first size based at least on the configuration. Sending unit 860 is then configured to send HARQ feedback to the network node using the HARQ codebook of the second size.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

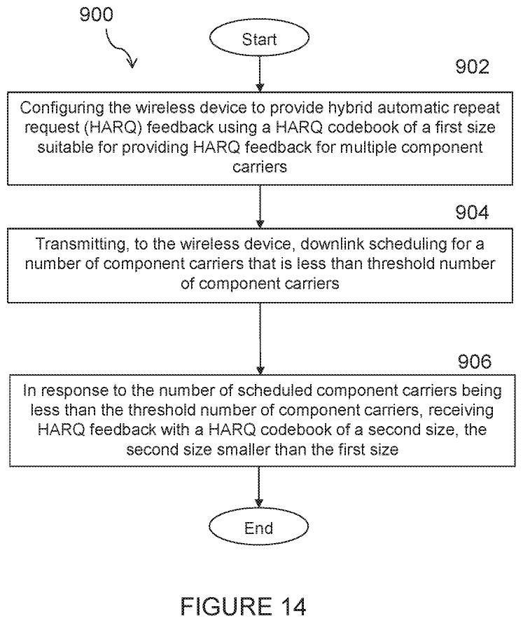

FIG. 14 depicts another method by a network node 160 for scheduling HARQ feedback from a wireless device 110, according to certain embodiments. In a particular embodiment, the network node 160 may include a base station.

The method begins at step 902 when network node 160 configures wireless device 110 to provide HARQ feedback using a HARQ codebook of a first size suitable for providing HARQ feedback for multiple component carriers.

At step 904, network node 160 transmits, to wireless device 110, downlink scheduling for a number of component carriers that is less than a threshold number of component carriers. In a particular embodiment, the downlink assignment indicates a PUCCH resource to use by the wireless device for sending the HARQ feedback of the second size to the network node.

At step 906, in response to the number of component carriers being less than the threshold number of component carriers, network node 160 receives HARQ feedback with a HARQ codebook of a second size that is smaller than the first size. In a particular embodiment, the HARQ codebook of the second size is fewer bits than the HARQ codebook of the first size. In another particular embodiment, the HARQ codebook that is the second size is determined based at least in part on a MIMO configuration. In still another particular embodiment, the HARQ codebook of the second size may be determined based on an association with a PUCCH resource indicated by the downlink assignment. In yet another particular embodiment, the HARQ feedback of the second size may be bundled across a plurality of code block groups.

In a particular embodiment, the method may further include network node 160 configuring wireless device 110 to use a PUCCH resource of a first size for providing HARQ feedback, but the HARQ feedback may be received using a PUCCH resource of a second size that is smaller than the first size. In a particular embodiment, for example, the PUCCH resource of the second size may be different from the PUCCH resource of the first size. In another particular embodiment, the PUCCH resource of the second size may be the same as the PUCCH resource of the first size.

In a particular embodiment, the downlink scheduling transmitted at step 904 may include a downlink assignment for a single component carrier to wireless device 110. Accordingly, the HARQ feedback received from wireless device 110 may be a single HARQ report for the downlink assignment. In a particular embodiment, for example, the single component carrier may be a primary downlink component carrier. In another particular embodiment, the single component carrier may be a downlink component carrier associated with an uplink component carrier of a PUCCH group that carries PUSCH.

In a particular embodiment, a power level for the HARQ codebook of the second size may be based on a power control loop of the PUCCH and at least one of: a size of the HARQ codebook of the first size and a size of the HARQ codebook of the second size.

In a particular embodiment, the downlink scheduling for the number of component carriers may be a downlink assignment for each of the number of component carriers, and the size of the HARQ codebook of the second size may be determined based on the number of component carriers.

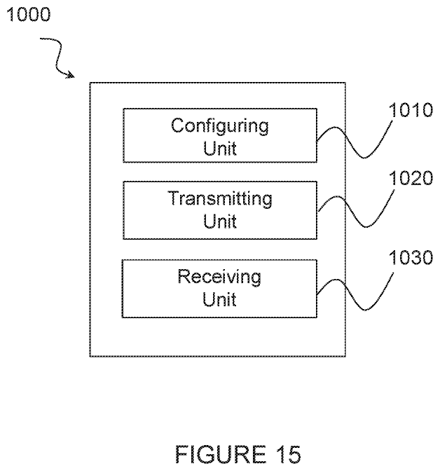

FIG. 15 illustrates another example virtualization apparatus 1000 in a wireless network (for example, the wireless network shown in FIG. 4), according to certain embodiments. Apparatus 1000 may be implemented in a network node (e.g., network node 160 shown in FIG. 4). In a particular embodiment, the virtualization apparatus may be implemented in a base station. Apparatus 1000 is operable to carry out the example method described with reference to FIG. 14 and possibly any other processes or methods disclosed herein. It is also to be understood that the method of FIG. 14 is not necessarily carried out solely by apparatus 1000. At least some operations of the method can be performed by one or more other entities.

Virtual Apparatus 1000 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause configuring unit 1010, transmitting unit 1020, receiving unit 1030, and any other suitable units of apparatus 1000 to perform corresponding functions according one or more embodiments of the present disclosure.

As illustrated in FIG. 15, apparatus 1000 includes configuring unit 1010, transmitting unit 1020, and receiving unit 1030. In certain embodiments, configuring unit 1010 is configured to configure wireless device 110 to provide HARQ feedback using a HARQ codebook of a first size suitable for providing HARQ feedback for multiple component carriers. Transmitting unit 1020 is configured to transmit, to wireless device 110, downlink scheduling for a number of component carriers that is less than a threshold number of component carriers. In response to the number of component carriers being less than the threshold number of component carriers, receiving unit 1030 is configured to receive HARQ feedback with a HARQ codebook of a second size that is smaller than the first size.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### EMBODIMENTS

### Group A Embodiments

1. A method performed by a wireless device for transmitting HARQ feedback to a base station, the method comprising:
obtaining a configuration to provide hybrid automatic repeat request (HARQ) feedback, the configuration including a HARQ codebook of a first size suitable for providing HARQ feedback for multiple component carriers;
receiving, from a network node, downlink scheduling for a number of component carriers;
determining the number of scheduled component carriers is less than a threshold number of component carriers;
determining a HARQ codebook of a second size, the second size smaller than the first size; and
sending HARQ feedback to the network node using the HARQ codebook of the second size.

2. The method of the previous embodiment, wherein:
the obtained configuration further comprises a physical uplink control channel (PUCCH) resource of a first size; and
sending HARQ feedback comprises sending HARQ feedback using a PUCCH resource of a second size, the second size smaller than the first size.

### Group B Embodiments

3. A method performed by a base station for scheduling HARQ feedback from a wireless device, the method comprising:
configuring the wireless device to provide hybrid automatic repeat request (HARQ) feedback using a HARQ codebook of a first size suitable for providing HARQ feedback for multiple component carriers;
scheduling the wireless device for a number of component carriers;
determining the number of scheduled component carriers is less than a threshold number of component carriers; and
receiving HARQ feedback with a HARQ codebook of a second size, the second size smaller than the first size.

4. The method of the previous embodiment, further comprising configuring the wireless device to use a physical uplink control channel (PUCCH) resource of a first size for providing HARQ feedback; and wherein receiving the HARQ feedback comprises receiving HARQ feedback using a PUCCH resource of a second size, the second size smaller than the first size.

### Group C Embodiments

5. A wireless device for transmitting HARQ feedback to a base station, the wireless device comprising:
processing circuitry configured to perform any of the steps of any of the Group A embodiments; and
power supply circuitry configured to supply power to the wireless device.

6. A base station for scheduling HARQ feedback from a wireless device, the base station comprising:
processing circuitry configured to perform any of the steps of any of the Group B embodiments;
power supply circuitry configured to supply power to the wireless device.

7. A user equipment (UE) for transmitting HARQ feedback to a base station, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 Ix Radio Transmission Technology
3GPP 3rd Generation Partnership Project
5G 5th Generation
ABS Almost Blank Subframe
ACK Acknowledgement
ACK/NACK Acknowledgement/Not-acknowledgement
ARQ Automatic Repeat Request
AWGN Additive White Gaussian Noise
BCCH Broadcast Control Channel
BCH Broadcast Channel
CA Carrier Aggregation
CBG Code Block Group
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
C01 Channel Quality information
C-RNTI Cell RNTI
CSI Channel State Information
DAI Downlink Assignment Indicator
DCI Downlink Control Information
DCCH Dedicated Control Channel
DFT Discrete Fourier Transform
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
ABS Almost Blank Subframe
MDT Minimization of Drive Tests
MIB Master Information Block
MME Mobility Management Entity
MSC Mobile Switching Center
NACK Not-acknowledgement
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PAPR Peak to Average Power Ratio
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PR PUCCH Resource
PRACH Physical Random Access Channel
PRB Physical Resource Block
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SR Scheduling Request
SS Synchronization Signal
SSS Secondary Synchronization Signal
TDD Time Division Duplex
TDM Time Division Multiplexing
TDOA Time Difference of Arrival
TOA Time of Arrival
TSS Tertiary Synchronization Signal
TTI Transmission Time Interval
UCI Uplink Control Information
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1. A method performed by a wireless device for transmitting hybrid automatic repeat request (HARQ) feedback to a base station, the method comprising:
obtaining a configuration to provide HARQ feedback;
determining a HARQ codebook of a first size suitable for providing HARQ feedback for multiple component carriers based at least on the configuration;
receiving, from a network node, downlink scheduling for a number of component carriers;
determining the number of scheduled component carriers is less than a threshold number of component carriers;
determining a HARQ codebook of a second size based on at least the configuration, the second size smaller than the first size; and
sending HARQ feedback to the network node using the HARQ codebook of the second size.

2. The method of claim 1, wherein:
the obtained configuration further comprises a physical uplink control channel (PUCCH) resource of a first size; and
sending HARQ feedback comprises sending HARQ feedback using a PUCCH resource of a second size, the second size smaller than the first size.

3. (canceled)

4. (canceled)

5. The method of claim 1, wherein:
the downlink scheduling for the number of component carriers comprises a downlink assignment for a single component carrier within a PUCCH group, and
the HARQ feedback comprises a single HARQ report for the downlink assignment.

6. The method of claim 5, wherein the downlink assignment indicates a PUCCH resource to use for sending the HARQ feedback of the second size to the network node.

7. The method of claim 6, wherein the HARQ codebook of the second size is determined based on an association with the PUCCH resource indicated by the downlink assignment.

8. (canceled)

9. (canceled)

10. The method of claim 1, wherein the HARQ codebook of the second size is fewer bits than the HARQ codebook of the first size.

11. The method of claim 10, wherein the HARQ codebook of the second size is determined based at least in part on a multi input multi output (MIMO) configuration.

12. The method of claim 1, wherein determining the HARQ codebook of the second size comprises generating the HARQ feedback of the second size by bundling across a plurality of code block groups.

13. (canceled)

14. The method of claim 1, wherein:
the downlink scheduling for the number of component carriers comprises a downlink assignment for each of the number of component carriers, and
the size of the HARQ codebook of the second size is determined based on the number of component carriers.

15. A wireless device for transmitting hybrid automatic repeat request (HARQ) feedback to a base station, the wireless device comprising:
processing circuitry configured to:
obtain a configuration to provide HARQ feedback;
determining a HARQ codebook of a first size suitable for providing HARQ feedback for multiple component carriers based at least on the configuration;
receive, from a network node, downlink scheduling for a number of component carriers;
determine the number of scheduled component carriers is less than a threshold number of component carriers;
determine a HARQ codebook of a second size based at least on the configuration, the second size smaller than the first size; and
send HARQ feedback to the network node using the HARQ codebook of the second size.

16. The wireless device of claim 15, wherein:
the obtained configuration further comprises a physical uplink control channel (PUCCH) resource of a first size; and
sending HARQ feedback comprises sending HARQ feedback using a PUCCH resource of a second size, the second size smaller than the first size.

17-25. (canceled)

26. The wireless device of claim 15, wherein determining the HARQ codebook of the second size comprises generating the HARQ feedback of the second size by bundling across a plurality of code block groups.

27. The wireless device of claim 15, wherein the processing circuitry is configured to:
based on an uplink power control rule, determine a power level for the HARQ codebook of the second size, the power level based on a power control loop of the PUCCH and at least one of:
a size of the HARQ codebook of the first size, and
a size of the HARQ codebook of the second size, and
wherein the power level is used for sending the HARQ feedback of the second size is sent to the network node.

28. (canceled)

29. A method performed by a base station for scheduling hybrid automatic repeat request (HARQ) feedback from a wireless device, the method comprising:
configuring the wireless device to provide HARQ feedback using a HARQ codebook of a first size suitable for providing HARQ feedback for multiple component carriers;
transmitting, to the wireless device, downlink scheduling for a number of component carriers that is less than a threshold number of component carriers; and
in response to the number of component carriers being less than the threshold number of component carriers, receiving HARQ feedback with a HARQ codebook of a second size, the second size smaller than the first size.

30. The method of claim 29, further comprising configuring the wireless device to use a physical uplink control channel (PUCCH) resource of a first size for providing HARQ feedback; and wherein receiving the HARQ feedback comprises receiving HARQ feedback using a PUCCH resource of a second size, the second size smaller than the first size.

31. (canceled)

32. (canceled)

33. The method of claim 29, wherein:
the downlink scheduling comprises a downlink assignment for a single component carrier to the wireless device, and
the HARQ feedback received from the wireless device comprises a single HARQ report for the downlink assignment.

34. (canceled)

35. (canceled)

36. The method of claim 33, wherein the single component carrier comprises a primary downlink component carrier.

37. The method of claim 33, wherein the single component carrier comprises a downlink component carrier associated with an uplink component carrier of a PUCCH group that carries PUSCH.

38. The method of claim 29, wherein the HARQ codebook of the second size is fewer bits than the HARQ codebook of the first size.

39. The method of claim 38, wherein the HARQ codebook that is the second size is determined based at least in part on a multi input multi output (MIMO) configuration.

40. The method of claim 29, wherein the HARQ feedback of the second size is bundled across a plurality of code block groups.

41. The method of claim 29, wherein a power level for the HARQ codebook of the second size is based on a power control loop of the PUCCH and at least one of:
a size of the HARQ codebook of the first size, and
a size of the HARQ codebook of the second size.

42. (canceled)

43. A base station for scheduling hybrid automatic repeat request (HARQ) feedback from a wireless device, the base station comprising:
processing circuitry configured to:
configure the wireless device to provide HARQ feedback using a HARQ codebook of a first size suitable for providing HARQ feedback for multiple component carriers;
transmit, to the wireless device, downlink scheduling for a number of component carriers that is less than a threshold number of component carriers; and
in response to the number of component carriers being less than the threshold number of component carriers, receive HARQ feedback with a HARQ codebook of a second size, the second size smaller than the first size.

44. The base station of claim 43, wherein the processing circuitry is configured to configure the wireless device to use a physical uplink control channel (PUCCH) resource of a first size for providing HARQ feedback; and wherein receiving the HARQ feedback comprises receiving HARQ feedback using a PUCCH resource of a second size, the second size smaller than the first size.

45-53. (canceled)

54. The base station of claim 43, wherein the HARQ feedback of the second size is bundled across a plurality of code block groups.

55. (canceled)

56. The base station of claim 43, wherein:
the downlink scheduling for the number of component carriers comprises a downlink assignment for each of the number of component carriers, and
the size of the HARQ codebook of the second size is determined based on the number of component carriers.
